(19) United States
(12) Patent Application Publication
(10) Pub. No.: US 2009/0102768 A1
(43) Pub. Date: Apr. 23, 2009

(54) IMAGING DEVICE AND DISPLAY APPARATUS

(75) Inventor: Kazuo Shimizu, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 12/245,039

(22) Filed: Oct. 3, 2008

(30) Foreign Application Priority Data
Oct. 17, 2007 (JP) 2007270055

(51) Int. Cl. G02F 1/1335

(52) U.S. Cl. 345/88

(57) ABSTRACT

An imaging device includes on-chip color filters in four or more colors, and these on-chip color filters are arranged two-dimensionally in a mosaic form. Focusing on only on-chip color filters of the same color from among the on-chip color filters, these on-chip color filters are arranged such that an arrangement pitch between adjacent on-chip color filters is substantially constant. The arrangement pitch can also be made substantially identical among on-chip color filters of different colors.

### FIELD OF THE INVENTION

This invention relates to an imaging device and a display apparatus, and more particularly to a color imaging device capable of color separation into four or more colors, and a color display apparatus having four or more display primary colors.

### DESCRIPTION OF THE RELATED ART

In an imaging device having an on-chip color filter, color filters in a plurality of colors (having a plurality of spectral transmission characteristics) are arranged two-dimensionally on the surface of the imaging device. The imaging device is constituted such that light passing through the color filters is received by a plurality of photodiodes provided corresponding to the respective color filters, whereupon a color image signal is outputted. On-chip color filters in three colors, namely red, green and blue (RGB), are arranged two-dimensionally on the surface of an imaging device that generates red, blue, green three-primary color image signals. A Bayer arrangement is well known as an arrangement method. In the Bayer arrangement, four pixels comprising two vertical pixels and two horizontal pixels form a single unit. A green (G) filter is provided on the photodiodes corresponding to the two pixels arranged diagonally, a red (R) filter is provided on the photodiode corresponding to one of the two remaining pixels, and a blue (B) filter is provided on the photodiode corresponding to the other pixel (see specifications of JP2003-37848A and Japanese Patent No. 3501694). Demosaicing processing and the like is then performed on the image signal obtained in accordance with the pixels, and thus color information for each color of RGB can be provided in relation to each individual pixel. It should be noted that in this specification, portions corresponding to respective light receiving units of the plurality of photodiodes provided in the imaging device are referred to as “pixels”. In other words, a single pixel is constituted to receive the light that passes through a single on-chip color filter. In an imaging device having on-chip color filters arranged in the Bayer arrangement described above, G filters are provided on half of the entire number of pixels, while B filters and R filters are provided respectively on the remaining quarters.

An imaging device was described above. A color display apparatus will now be described. A liquid crystal display apparatus (LCD) may be cited as a representative example of a color display apparatus. Color filters in three colors, namely RGB, are typically arranged regularly on the surface of an LCD capable of color display with the three colors, i.e. RGB, forming a single group. An intended color is reproduced by employing liquid crystal to control an amount of emitted light (display primary color light) passing through the respective RGB filters. In this specification, parts through which emitted light in each of RGB passes in an RGB display apparatus, for example, are referred to as “sub-pixels”, and a part formed by gathering together one sub-pixel in each of RGB is referred to as a “display pixel”. In other words, by varying an intensity ratio of the display primary color light emitted from each of the RGB sub-pixels, the color (hue, chroma, brightness) of the light emitted from a single display pixel can be varied.

In recent years, improvements in color reproducibility have been demanded, and attempts have been made to increase the number of colors used during color separation in the imaging device described above and increase the number of display primary colors in a color display device in order to widen the reproducible gamut and increase the capacity for reproducing minute color differences. A system known as “Natural Vision” has been proposed as a system aiming for more realistic color reproduction using four or more display primary colors. Two systems to be described below may be cited as typical examples of an apparatus that performs image pick-up using color filters in four or more colors. In one system, plane-sequential images are input by repeating image pick-up of an identical scene while switching color filters in a plurality of colors provided on a turret, and as a result, a multiband image signal is generated. In the other system, object light passing through an imaging lens is divided by a beam splitter into light that travels along two optical paths, then dispersed into light distributed among three wavelength bands by dichroic prisms disposed on each optical path, and then led to six imaging devices to generate a 6-band image signal. The former system is suitable for still photography, while the latter is suitable for both still photography and video recording.

Meanwhile, a system in which a 6-band image signal is separated into two groups of image signals having three bands each and then output to two projectors is known as a display system enabling Natural Vision image display. Each projector has three display primary colors, but the combinations of display primary colors differ between the two projectors. By superimposing images generated by the two projectors on a screen, a 6-primary color image can be displayed.

### SUMMARY OF THE INVENTION

An imaging apparatus and a display apparatus used in the Natural Vision system both have complicated hardware constitutions, and further improvements in size reduction and simplification are required. To reduce the size of the imaging apparatus, color separation into multiple primary colors may be achieved by increasing the number of colors of the on-chip color filters provided in an imaging device of a single-plate type (increasing the number of colors of the pixel). Further, to realize multiband display on a display apparatus such as an LCD, the number of colors of the sub-pixel may be increased.

However, the pixels on an imaging device and the sub-pixels on an LCD are both arranged two-dimensionally on a plane surface. Hence, when the number of colors is increased, the number of pixels constituting a single group in the imaging device and the number of sub-pixels constituting a single display pixel in the display apparatus increase, making it difficult in some cases to perform ideal color mixing. Here, color mixing in an imaging device denotes detecting the light quantity of light passing through respective on-chip color filters in a plurality of colors arranged two-dimensionally on a light receiving surface of the imaging device with photodiodes, and obtaining the color (RGB values, etc.) of the light that enters an arrangement region of the on-chip color filters from a light quantity ratio of the light that passes through the on-chip color filters of the respective colors. Further, color mixing in a display apparatus denotes adjusting the light quantity ratio of light emanating from the sub-pixels of each display primary color forming a single display pixel to control the color and intensity of the light emitted from the single display pixel.

To describe an example of an imaging device having on-chip color filters, the number of colors in an imaging device having three-color RGB on-chip color filters is small. Therefore, a filter arrangement whereby an on-chip color filter of a certain color is adjacent to the on-chip color filters of the other two colors in any of an up-down direction, a left-right direction, and a diagonal direction is employed. It is therefore comparatively easy to achieve even color mixing. In other words, when processing an image signal obtained from a single-plate type imaging device, color information relating to light that enters in a plurality of spatially removed entrance points is used to determine the colors in the vicinity of the entrance point through interpolation, and therefore it is easier to achieve even color mixing when distances between the plurality of entrance points are not too great.

However, when the number of filter colors is increased, it becomes difficult to maintain a filter arrangement such as that described above. As a result, color reproduction may not be performed favorably, false color may occur depending on the object image pattern formed on the imaging surface, the resolution may differ according to color differences, and stripe-like patterns not present on the original object image may appear.

Likewise with regard to the display apparatus, when an attempt is made to generate a color by mixing together two display primary colors, the distance between the sub-pixels corresponding to the two display primary colors may differ according to the combination of the display primary colors to be mixed, leading to an uneven color mixing characteristic and making it difficult to perform favorable color reproduction.

This invention has been designed in consideration of the problems described above, and it is an object thereof to provide a technique enabling color mixing in a near ideal state during image capture and display using four or more colors.
(1) This invention solves the problems described above when applied to an imaging device having on-chip color filters in four or more colors, wherein the on-chip color filters in four or more colors are arranged two-dimensionally such that in relation to an arrangement pitch between on-chip color filters of an identical color, the arrangement pitch between adjacent on-chip color filters is substantially constant.
(2) This invention is also applied to a display apparatus having display primary color light emitting units in four or more colors, wherein the display primary color light emitting units in four or more colors are arranged two-dimensionally such that in relation to an arrangement pitch between display primary color light emitting units of an identical color, the arrangement pitch between display primary color light emitting units is substantially constant.

### BRIEF DESCRIPTION OF THE DRAWINGS

For a more complete understanding of the present invention, the objects and advantages thereof, reference is now made to the following descriptions taken in connection with the accompanying drawings.

FIG. 1A is a schematic diagram showing an arrangement example of on-chip color filters of an imaging device according to a first embodiment of this invention, in which a plurality of groups constituted respectively by six on-chip color filters are provided.

FIG. 1B is a schematic diagram showing a single group of on-chip color filters in the arrangement example of the on-chip color filters of the imaging device according to the first embodiment of this invention.

FIG. 2 is a view illustrating the manner in which on-chip color filters of the same color are arranged in the imaging device according to the first embodiment of this invention.

FIG. 3A is a schematic diagram showing an arrangement example of on-chip color filters of an imaging device according to a second embodiment of this invention, in which a plurality of groups constituted respectively by nine on-chip color filters are provided.

FIG. 3B is a schematic diagram showing a single group of on-chip color filters in the arrangement example of the on-chip color filters of the imaging device according to the second embodiment of this invention.

FIG. 4 is a view illustrating an example of a spectral transmission characteristic of each of the plurality of on-chip color filters forming a single group.

FIG. 5 is a view illustrating the manner in which on-chip color filters of the same color are arranged in the imaging device according to the second embodiment of this invention.

### DETAILED DESCRIPTION OF THE PREFERRED EMBODIMENTS

### First Embodiment

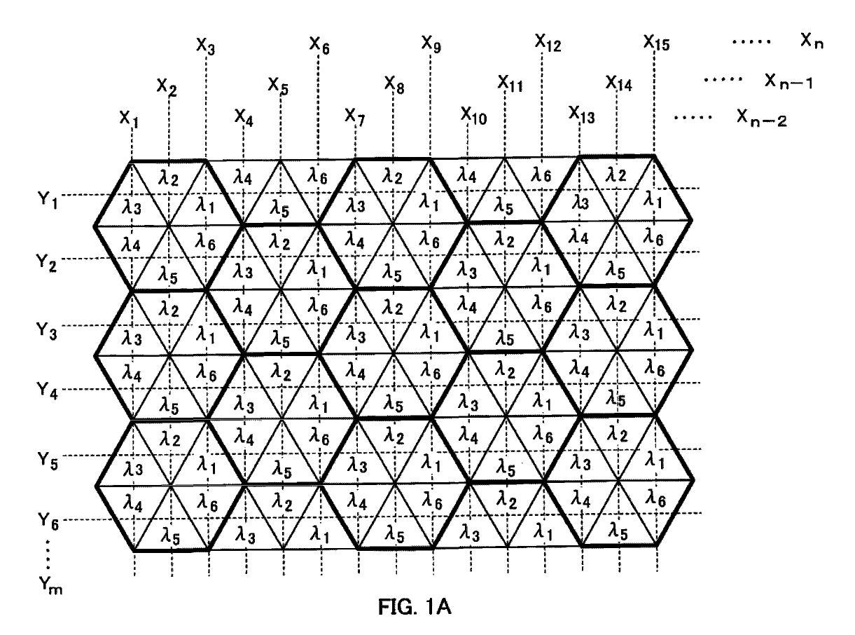

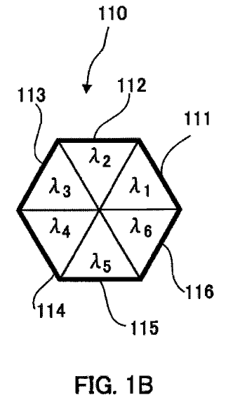

FIG. 1 is a schematic top view showing an arrangement example of on-chip color filters provided on a light receiving surface of an imaging device according to a first embodiment of this invention. FIG. 1A shows a state in which a plurality of groups constituted respectively by six on-chip color filters are provided, and FIG. 1B is a view showing the manner in which a single group is formed from six on-chip color filters. In this specification, the term “group” is used to express the cyclical property or regularity of an arrangement of on-chip color filters or pixels, and does not necessarily mean that the on-chip color filters or pixels of a single group are physically combined.

An on-chip color filter group 110 includes six on-chip color filters 111, 112, 113, 114, 115, 116. Each of the on-chip color filters 111, 112, 113, 114, 115, 116 preferably has a triangular outer shape, or more preferably an equilaterally triangular outer shape, but other outer shapes may be used. In FIG. 1, the on-chip color filters 111, 112, 113, 114, 115, 116 are depicted as having an equilaterally triangular outer shape. In FIG. 1, each of the six on-chip color filters 111, 112, 113, 114, 115, 116 has three apexes. The on-chip color filter group 110 is formed by arranging the six on-chip color filters 111, 112, 113, 114, 115, 116 such that a single apex of each on-chip color filter gathers in a single point. The overall outer shape of the on-chip color filter group 110 is hexagonal, or preferably equilaterally hexagonal. By arranging the on-chip color filters in this manner, the six on-chip color filters 111, 112, 113, 114, 115, 116 can be arranged in equidistant positions about a central position of the on-chip color filter group 110, and therefore color mixing in the pixels of a single group can be performed evenly, enabling an improvement in color reproducibility.

A light receiving unit (not shown) is provided beneath (assuming that a direction extending from a front side to a rear side of the paper surface in FIG. 1 corresponds to a vertical direction) each of the on-chip color filters 111, 112, 113, 114, 115, 116 in accordance with the on-chip color filters 111, 112, 113, 114, 115, 116. The light receiving unit may take an identical shape to the on-chip color filter. A single pixel is constituted by one of the on-chip color filters 111, 112, 113, 114, 115, 116 and the light receiving unit disposed therebeneath. By forming the on-chip color filters 111, 112, 113, 114, 115, 116 with an equilaterally triangular outer shape, as shown in FIG. 1, six triangular pixels are formed from the on-chip color filters 111, 112, 113, 114, 115, 116 and the light receiving units disposed beneath the on-chip color filters. Together, these six pixels constitute a single pixel group having a hexagonal shape.

The on-chip color filters 111, 112, 113, 114, 115, 116 may have different spectral transmission characteristics, and in this case, six types of color information can be obtained from a single pixel group. Alternatively, two or three on-chip color filters from among the on-chip color filters 111, 112, 113, 114, 115, 116 may have the same spectral transmission characteristic. When two on-chip color filters have the same spectral transmission characteristic, five types of color information can be obtained from a single pixel group. When three on-chip color filters have the same spectral transmission characteristic, four types of color information can be obtained from a single pixel group. When a plurality of on-chip color filters are set to have the same spectral transmission characteristic, the spectral transmission characteristic preferably includes green, to which the human eye exhibits high spectral sensitivity, in order to improve the apparent resolution of an image generated on the basis of a signal output by the imaging device.

When the respective spectral transmission characteristics of the on-chip color filters 111, 112, 113, 114, 115, 116 are represented by λ1, λ2, λ3, λ4, λ5, λ6, setting can be performed such that λ1, λ3 and λ5 have spectral transmission characteristics in which the transmission center wavelength is red (R), green (G), and blue (B), respectively, while λ2, λ4 and λ6 have spectral transmission characteristics in which the transmission center wavelength is yellow (Y), magenta (M), and cyan (C), respectively. In other words, setting can be performed such that of the six on-chip color filters, three have primary color-based spectral transmission characteristics, and the remaining three have complementary color-based spectral transmission characteristics. Alternatively, setting can be performed such that λ1, λ3 and λ5 have spectral transmission characteristics in which the transmission center wavelength is red (R), green (G), and blue (B), respectively, while λ2, λ4 and λ6 have spectral transmission characteristics in which the respective transmission center wavelengths deviate by approximately several tens of nm from the transmission center wavelengths of λ1, λ2 and λ3. Further, of the six on-chip color filters, one or a plurality of on-chip color filters may have a wider spectral transmission wavelength band than the spectral transmission wavelength bands of the other on-chip color filters. The combination of spectral transmission characteristics may be varied in accordance with the imaging device application, for example a consumer application, an industrial application, or a medical application. For example, the combination of spectral transmission characteristics may be varied such that an image emphasizing a difference that cannot be perceived by the naked eye can be obtained.

Here, a single pixel group constituted by six pixels is described as a hexagonal tile. The tiles form a densely arranged zigzag pattern, as shown in FIG. 1A. With this arrangement, a larger amount of pixels can be disposed within the limited imaging area of the imaging device.

In FIG. 1A, broken lines having the reference symbols X1 to X15 and Y1 to Y6 schematically indicate address lines. In the imaging device according to the first embodiment of this invention, similarly to an imaging device having a conventional Bayer arrangement, row direction address lines and column direction address lines can be disposed at substantially equal intervals in the form of straight lines extending respectively in a parallel direction to the row direction and column direction.

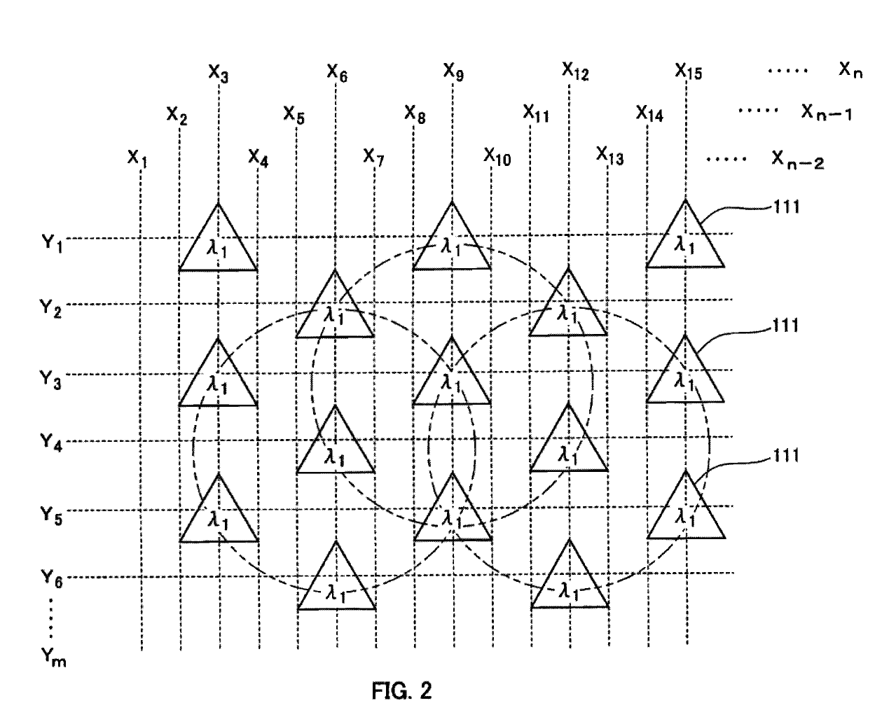

A further feature of the on-chip color filter arrangement used in the imaging device according to the first embodiment of this invention will now be described with reference to FIG. 2. FIG. 2 shows only the on-chip color filters 111 having the spectral transmission characteristic λ1, which have been extracted from the on-chip color filter arrangement shown in FIG. 1A. As shown by the dot-dot-dash line circles in FIG. 2, an arrangement pitch between the on-chip color filters 111 is substantially constant. In other words, the arrangement positions of the on-chip color filters 111 are determined such that a certain on-chip color filter 111 (for example, the on-chip color filter 111 positioned in the center of the circle) and the on-chip color filters 111 positioned on the periphery of this on-chip color filter 111 (i.e. the on-chip color filters 111 positioned on the circumference of the circle) all have a substantially constant arrangement pitch. As a result, the on-chip color filters 111 of the same color (spectral transmission characteristic) are arranged two-dimensionally at a substantially constant arrangement pitch in relation to the adjacent on-chip color filters 111.

Similarly, the on-chip color filters 112, 113, 114, 115, 116 having other spectral transmission characteristics are arranged two-dimensionally such that the arrangement pitch between on-chip color filters of the same color is substantially constant. In addition, the on-chip color filters 111, 112, 113, 114, 115, 116 are preferably arranged such that the on-chip color filters of all colors have a substantially equal arrangement pitch (the on-chip filters of all colors are arranged at a substantially equal arrangement pitch).

By arranging the on-chip color filters 111, 112, 113, 114, 115, 116 in the manner described above, stable color mixing is achieved in all locations on the imaging surface of the imaging device, and therefore color unevenness, false color, “stripe-like patterns”, and so on are less likely to occur on a generated color image. Thus, an imaging apparatus that is capable of reproducing the colors of an object more faithfully can be provided.

An example in which this invention is applied to an imaging device was described above, but this invention may also be applied to a display apparatus. A case in which this invention is applied to a TFT color liquid crystal display apparatus, for example, will now be described. The shape of the color filters constituting the sub-pixels (display primary color light emitting units) is triangular, or preferably equilaterally triangular, and the color filters are disposed so as to come into point contact at one of the three apexes possessed by each filter, as shown in FIG. 1B. As a result, a display pixel having an overall hexagonal shape can be formed.

TFT liquid crystal having display segments of a substantially identical shape to the color filter is formed beneath the six color filters (between the color filters and a back light). The light transmittance of the respective display segments is controlled by the TFT liquid crystal to achieve color mixing through control of the intensity of emitted light (display primary color light) passing through the respective color filters, and thus color control of the entire display pixel is achieved. At this time, as described above, the color filters having the same spectral transmission characteristic are arranged two-dimensionally such that the arrangement pitch between adjacent color filters is substantially constant. Further, by arranging the color filters such that the arrangement pitches of the color filters having the respective spectral transmission characteristics are substantially equal (the color filters having respective spectral transmission characteristics are arranged at a substantially equal arrangement pitch), even color mixing can be achieved in all locations of a display screen. Moreover, by setting the shape and arrangement of the display segments as shown in FIG. 1A, address lines and data lines can be formed linearly, and therefore a pattern of transparent electrodes formed on a transparent substrate that constitutes the liquid crystal display apparatus can be simplified.

An example in which this invention is applied to a TFT liquid crystal display apparatus was described above, but this invention may also be applied to color display apparatuses employing other display systems. For example, this invention may be applied to a so-called self-luminous display apparatus such as an organic EL display, a plasma display, or a field emission display. In this case, the shape of the sub-pixel (display primary color light emitting unit) can be determined by setting the shape and arrangement of fluorescent bodies, electrodes, or light emitting units, depending on the operating principles of the apparatus, in the manner described above. In so doing, color mixing within a single display pixel can be performed in a manner closer to the ideal, and even color mixing can be achieved in all locations of the display screen.

### Second Embodiment

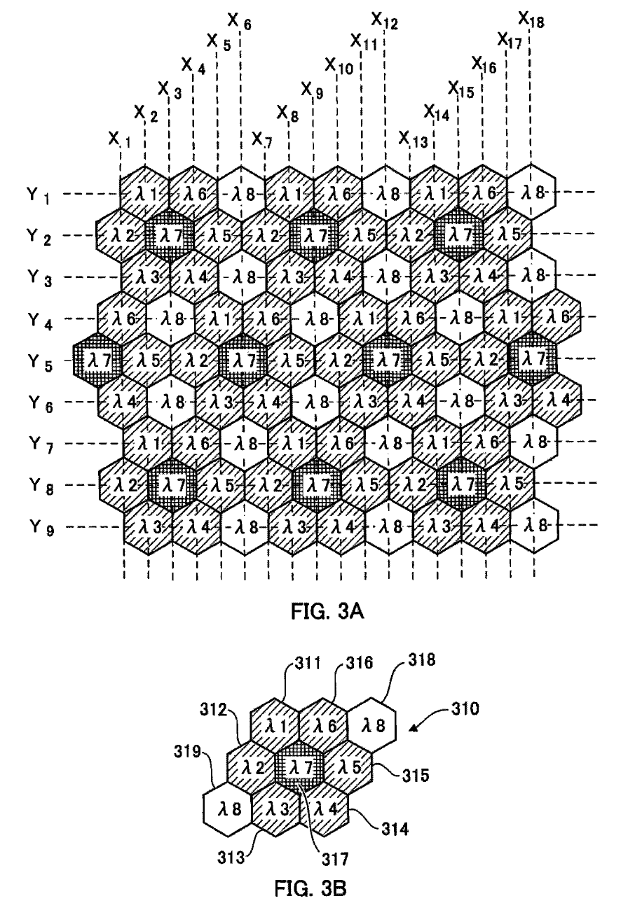

FIG. 3 is a schematic top view showing an arrangement example of on-chip color filters provided on a light receiving surface of an imaging device according to a second embodiment of this invention. FIG. 3A shows an arrangement of a plurality of groups constituted respectively by nine on-chip color filters, and FIG. 3B shows a single group formed from nine on-chip color filters.

An on-chip color filter group 310 includes nine on-chip color filters 311, 312, 313, 314, 315, 316, 317, 318, 319. Each of the on-chip color filters 311, 312, 313, 314, 315, 316, 317, 318, 319 preferably has a hexagonal outer shape, or more preferably an equilaterally hexagonal outer shape, but the outer shape may be set arbitrarily. In FIG. 3, the on-chip color filters 311, 312, 313, 314, 315, 316, 317, 318, 319 are depicted as having an equilaterally hexagonal outer shape. The arrangement structure of the on-chip color filters 311, 312, 313, 314, 315, 316, 317, 318, 319 will now be described. The on-chip color filter 317 having a spectral transmission characteristic λ7 is disposed in a central position of the on-chip color filter group 310, and six on-chip color filters 311, 312, 313, 314, 315, 316 are disposed so as to surround the on-chip color filter 317. The on-chip color filters 311, 312, 313, 314, 315, 316 have spectral transmission characteristics λ1, λ2, λ3, λ4, λ5, λ6, respectively. Further, two on-chip color filters 318, 319 are disposed on the outside of the area surrounded by the on-chip color filters 311, 312, 313, 314, 315, 316, and these on-chip color filters 318, 319 are disposed in rotationally symmetrical positions about the disposal position of the on-chip color filter 317 as a reference. The respective spectral transmission characteristics of the on-chip color filters 318, 319 may be different, but are preferably identical. In this embodiment, it is assumed that the on-chip color filters 318, 319 both have a spectral transmission characteristic λ8. As regards the respective spectral transmission characteristics λ1, λ2, λ3, λ4, λ5, λ6 of the on-chip color filters 111, 112, 113, 114, 115, 116 of the imaging device according to the first embodiment and the respective spectral transmission characteristics λ1, λ2, λ3, λ4, λ5, λ6, λ7, λ8 of the on-chip color filters 311, 312, 313, 314, 315, 316, 317, 318, 319 of the imaging device according to the second embodiment, spectral transmission characteristics having the same reference symbol may be identical or different.

A light receiving unit (not shown) is provided beneath (assuming that a direction extending from a front side to a rear side of the paper surface in FIG. 3 corresponds to a vertical direction) each of the on-chip color filters 311, 312, 313, 314, 315, 316, 317, 318, 319 in accordance with each of the on-chip color filters 311, 312, 313, 314, 315, 316, 317, 318, 319. The light receiving unit may take an identical shape to the on-chip color filter. A single pixel is constituted by one of the on-chip color filters 311, 312, 313, 314, 315, 316, 317, 318, 319 and the light receiving unit disposed therebeneath. In other words, nine hexagonal pixels are formed from the on-chip color filters 311, 312, 313, 314, 315, 316, 317, 318, 319 and the light receiving units disposed beneath the on-chip color filters, and a single pixel group having the arrangement structure described above with reference to FIG. 3B is formed from these nine pixels.

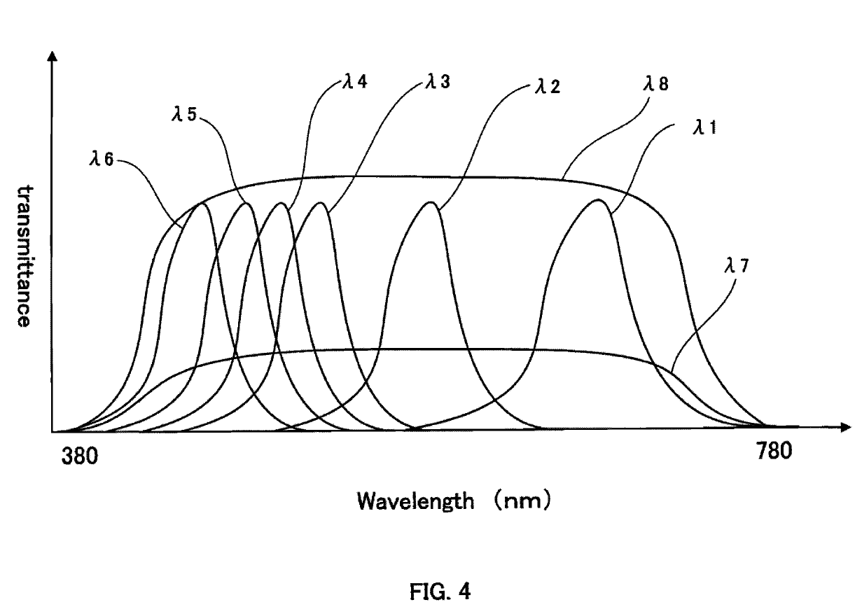

FIG. 4 shows an example of the respective spectral transmission characteristics λ1, λ2, λ3, λ4, λ5, λ6, λ7, λ8 of the on-chip color filters 311, 312, 313, 314, 315, 316, 317, 318, 319. As shown in FIG. 4, λ7 and λ8 have a wider transmission wavelength band than the transmission wavelength bands of λ1, λ2, λ3, λ4, λ5 and λ6. The overall transmittance of λ8 is set to be higher, whereas the overall transmittance of λ7 is set to be lower. By arranging the on-chip color filters 311, 312, 313, 314, 315, 316 having the spectral transmission characteristics λ1, λ2, λ3, λ4, λ5, λ6 (and having a comparatively narrow spectral transmission band) around the on-chip color filter 317 having the spectral transmission characteristic λ7 (and having a comparatively wide spectral transmission band), a plurality of on-chip color filters having a comparatively narrow spectral transmission band can be arranged in equidistant positions from an on-chip color filter having a comparatively wide spectral transmission band, and as a result, color mixing can be performed in a manner closer the ideal.

As shown in FIG. 4, the spectral transmission characteristic λ8 of the on-chip color filters 318, 319 has a comparatively wide spectral transmission band that preferably encompasses the visible range, and is also preferably a neutral spectral transmission characteristic. The reason for this is that the arrangement pitch between the respective on-chip color filters 318, 319 and the on-chip color filter 317 is different to, and greater than, the arrangement pitch between the respective on-chip color filters 311, 312, 313, 314, 315, 316 and the on-chip color filter 317, and therefore the color mixing characteristic may also be different. By making the spectral transmission characteristic λ8 of the on-chip color filters 318, 319 wider-band and neutral, the effect of the different color mixing characteristic on the color reproducibility can be reduced. Further, color information can be obtained from the pixels constituted by the on-chip color filters 311, 312, 313, 314, 315, 316, 317 and the light receiving units disposed beneath these on-chip color filters, and intensity information can be obtained from the on-chip color filters 318, 319 and the light receiving units disposed beneath these on-chip color filters.

Furthermore, by setting the spectral transmission characteristic λ7 of the on-chip color filter 317 to be wider-band and neutral, and to be lower overall than the spectral transmission characteristic λ8 of the on-chip color filter 318, as shown in FIG. 4, a dynamic range of the intensity information can be enlarged. When spectral transmission characteristics such as those shown in FIG. 4 are set, the pixel constituted by the on-chip color filter 317 and the light receiving unit disposed therebeneath responds to higher-intensity object light, whereas the pixels constituted by the on-chip color filters 318, 319 and the light receiving units disposed therebeneath respond to lower-intensity object light. The number of pixels responding to lower-intensity object light is larger, and therefore the surface area (light receiving area) of the light receiving units can be increased, enabling an improvement in the S/N ratio.

By mixing output from the pixel including the light receiving unit disposed beneath the on-chip color filter 317 and output from the pixels including the light receiving units disposed beneath the on-chip color filters 311, 312, 313, 314, 315, 316, lower-intensity object light setting, or in other words shadow level setting, is performed. At the same time, the on-chip color filters 311, 312, 313, 314, 315, 316 are disposed in adjacent positions to the on-chip color filter 317, and therefore favorable color mixing can be achieved, and the precision of shadow level adjustment can be improved.

When setting the high-intensity object light, or in other words the highlight level, output from the light receiving units disposed beneath the on-chip color filter 318 or the on-chip color filter 319 and the output from the light receiving units disposed beneath the on-chip color filters 311, 312, 313, 314, 315, 316 positioned adjacent (closest) thereto are mixed. Likewise during highlight level adjustment, the on-chip color filters 311, 312, 313, 314, 315, 316 are disposed in adjacent positions (close positions) to the on-chip color filter 318 or the on-chip color filter 319, and therefore favorable color mixing can be achieved, and the precision of highlight level adjustment can be improved. Furthermore, by mixing the output from the light receiving unit disposed beneath the on-chip color filter 318 or the on-chip color filter 319, the surface area of the light receiving units can be enlarged, enabling an improvement in intensity output.

The single pixel group constituted by the nine pixels is arranged as shown in FIG. 3B. A plurality of pixel groups having this shape are gathered together and arranged densely, as shown in FIG. 3A. With this arrangement, a larger number of pixels can be disposed within the limited imaging area of the imaging device.

In FIG. 3A, broken lines having the reference symbols X1 to X18 and Y1 to Y9 indicate address lines. In the imaging device according to the second embodiment of this invention, similarly to the imaging device according to the first embodiment, row direction address lines and column direction address lines can be disposed at substantially equal intervals in the form of straight lines extending respectively in a parallel direction to the row direction and column direction.

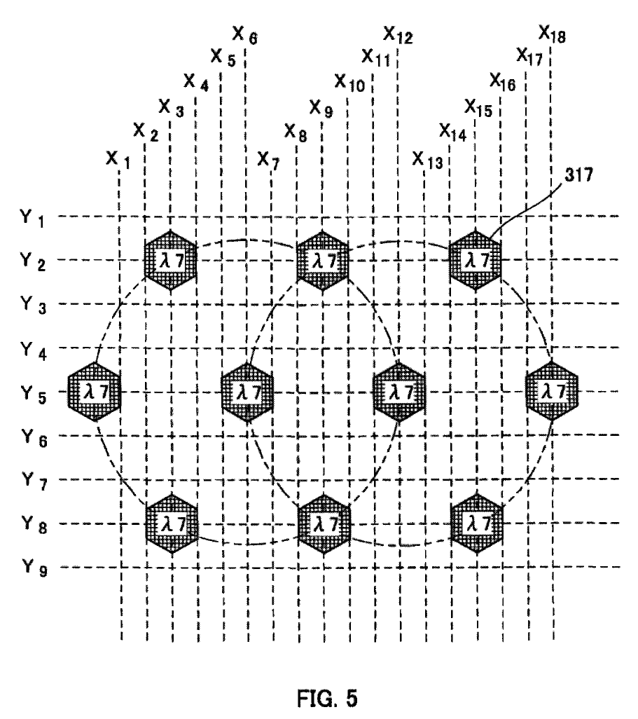

A further feature of the on-chip color filter arrangement used in the imaging device according to the second embodiment of this invention will now be described with reference to FIG. 5. FIG. 5 shows only the on-chip color filters 317 having the spectral transmission characteristic λ7, which have been extracted from the on-chip color filter arrangement shown in FIG. 3A. As shown by the dot-dot-dash line circles in FIG. 5, the arrangement pitch between the on-chip color filters 317 is substantially constant. In other words, the arrangement positions of the on-chip color filters 317 are determined such that a certain on-chip color filter 317 (for example, the on-chip color filter 317 positioned in the center of the circle) and the on-chip color filters 317 positioned on the periphery of this on-chip color filter 317 (i.e. the on-chip color filters 317 positioned on the circumference of the circle) all have a substantially constant arrangement pitch. As a result, the on-chip color filters 317 of the same color (spectral transmission characteristic) are arranged two-dimensionally at a substantially constant arrangement pitch in relation to the adjacent on-chip color filters 317.

Similarly, the on-chip color filters 311, 312, 313, 314, 315, 316, 318, 319 having other spectral transmission characteristics are arranged such that the arrangement pitch between on-chip color filters of the same color is substantially constant. In addition, the on-chip color filters 311, 312, 313, 314, 315, 316, 318, 319 are arranged such that the on-chip color filters of all colors have a substantially equal arrangement pitch.

By arranging the on-chip color filters 311, 312, 313, 314, 315, 316, 317, 318, 319 in the manner described above, stable color mixing is achieved in all locations on the imaging surface of the imaging device, and therefore artifacts such as color unevenness, false color, and “stripe-like patterns” are less likely to occur on a generated color image. Thus, an imaging apparatus that is capable of reproducing the colors of an object more faithfully can be provided.

An example in which this invention is applied to an imaging device was described above. As described in the first embodiment, however, this invention may also be applied to a display apparatus.

When this invention is used in a display apparatus, a single pixel (display pixel) is constituted by seven sub-pixels, excluding sub-pixels corresponding to the on-chip color filters 318 and 319, arranged in a star shape (disposed in a circle). The sub-pixels corresponding to the on-chip color filters 318 and 319 are interpolated for display from the sub-pixels corresponding to the peripheral on-chip color filters 311, 312, 313, 314, 315, 316. By performing interpolation from the peripheral sub-pixels in this manner, color balance adjustment can be performed favorably.

At this time, the spectral transmission bandwidth of the light emitted from the sub-pixel corresponding to the on-chip color filter 317 and the sub-pixels corresponding to the on-chip color filters 318 and 319 is preferably made wider. In addition, the spectral characteristics of these sub-pixels preferably has a neutral spectral radiance characteristic, and the radiance of the sub-pixels corresponding to the on-chip color filters 318 and 319 is preferably higher than the radiance of the sub-pixel corresponding to the on-chip color filter 317. In so doing, the intensity range of the light emitted from a single display pixel can be increased, and as a result, a display apparatus exhibiting a superior dynamic range and a superior tone characteristic can be provided.

Furthermore, the shape and arrangement of the sub-pixels may be set as shown in FIG. 3, while the spectral characteristic of the light emitted from each sub-pixel may be expressed by replacing the transmittance on the ordinate of the graph shown in FIG. 4 with radiance. In so doing, color mixing within a single display pixel can be performed in a manner close to the ideal, and even color mixing can be achieved in all locations of the display screen. Further, by providing the sub-pixels (display segments) with the shape and arrangement shown in FIG. 3A, address lines and data lines can be formed linearly, and therefore a pattern of transparent electrodes forming a transparent substrate that constitutes the liquid crystal display apparatus can be simplified, similarly to the first embodiment.

This invention may be used in an imaging device such as a CMOS image sensor or a CCD image sensor, a flat display apparatus such as a liquid crystal display apparatus, a plasma display apparatus, an organic EL display apparatus, or a field emission display apparatus, an image projection apparatus such as a data projector or a video projector, a rear projection image display apparatus, and so on.

Additional advantages and modifications will readily occur to those skilled in the art. Therefore, the invention in its broader aspects is not limited to the specific details and representative devices shown and described herein. Accordingly, various modifications may be made without departing from the spirit or scope of the general inventive concept as defined by the appended claims and their equivalents.

The entire contents of Japanese Patent Application JP2007-270055 (filed on Oct. 17, 2007) are incorporated herein by reference.

What is claimed is:

1. An imaging device having on-chip color filters in four or more colors, wherein the on-chip color filters in four or more colors are arranged two-dimensionally such that in relation to an arrangement pitch between on-chip color filters of an identical color, the arrangement pitch between adjacent on-chip color filters is substantially constant.

2. The imaging device as defined in claim 1, wherein the on-chip color filters in four or more colors are arranged two-dimensionally such that the arrangement pitch between the adjacent on-chip color filters of the same color is substantially equal in the on-chip color filters of all colors.

3. The imaging device as defined in claim 1, wherein the on-chip color filters are arranged such that six on-chip color filters form a single group.

4. The imaging device as defined in claim 3, wherein the on-chip color filter group has a hexagonal overall outer shape, and the respective on-chip color filters constituting the on-chip color filter group have a triangular outer shape.

5. The imaging device as defined in claim 1, wherein the on-chip color filters are arranged such that nine on-chip color filters form a single group.

6. The imaging device as defined in claim 5, wherein the respective on-chip color filters constituting the on-chip color filter group have a hexagonal outer shape.

7. The imaging device as defined in claim 5, wherein the on-chip color filters are formed into the single group by disposing second to seventh on-chip color filters so as to surround a periphery of a first on-chip color filter disposed in a central position, and disposing eighth and ninth on-chip color filters in rotationally symmetrical positions, with respect to a disposal position of the first on-chip color filter as a reference, on an outside of an area surrounded by the second to seventh on-chip color filters.

8. The imaging device as defined in claim 7, wherein a transmission wavelength bandwidth of the first on-chip color filter is wider than respective transmission wavelength bandwidths of the second to seventh on-chip color filters.

9. The imaging device as defined in claim 7, wherein a transmission wavelength bandwidth of the eighth and ninth on-chip color filters is wider than respective transmission wavelength bandwidths of the second to seventh on-chip color filters, and
the eighth and ninth on-chip color filters have a substantially equal spectral transmission characteristic.

10. A display apparatus having display primary color light emitting units in four or more colors, wherein the display primary color light emitting units in four or more colors are arranged two-dimensionally such that in relation to an arrangement pitch between display primary color light emitting units of an identical color, the arrangement pitch between adjacent display primary color light emitting units is substantially constant.

11. The display apparatus as defined in claim 10, wherein the display primary color light emitting units in four or more colors are arranged two-dimensionally such that the arrangement pitch between the adjacent display primary color light emitting units of the same color is substantially equal in the display primary color light emitting units of all colors.

12. The display apparatus as defined in claim 10, wherein the display primary color light emitting units are arranged such that six display primary color light emitting units form a single group.

13. The display apparatus as defined in claim 12, wherein the display primary color light emitting unit group has a hexagonal overall outer shape, and the respective display primary color light emitting units constituting the display primary color light emitting unit group have a triangular outer shape.

14. The display apparatus as defined in claim 10, wherein the display primary color light emitting units are arranged such that nine display primary color light emitting units form a single group.

15. The display apparatus as defined in claim 14, wherein the respective display primary color light emitting units forming the display primary color light emitting unit group have a hexagonal outer shape.

16. The display apparatus as defined in claim 14, wherein the display primary color light emitting units are formed into the single group by disposing second to seventh display primary color light emitting units so as to surround a periphery of a first display primary color light emitting unit disposed in a central position, and disposing eighth and ninth display primary color light emitting units in rotationally symmetrical positions, with respect to a disposal position of the first display primary color light emitting unit as a reference, on an outside of an area surrounded by the second to seventh display primary color light emitting units.

17. The display apparatus as defined in claim 16, wherein a wavelength bandwidth of light emitted from the first display primary color light emitting unit is wider than respective wavelength bandwidths of light emitted from the second to seventh display primary color light emitting units.

18. The imaging device as defined in claim 16, wherein a wavelength bandwidth of light emitted from the eighth and ninth display primary color light emitting units is wider than respective wavelength bandwidths of light emitted from the second to seventh display primary color light emitting units, and
spectral radiance characteristics of the light emitted from the eighth and ninth display primary color light emitting units are substantially equal.
